(19) United States
(12) Patent Application Publication
(10) Pub. No.: US 2025/0298378 A1
(43) Pub. Date: Sep. 25, 2025

(54) DECORATIVE BEZEL UNIT AND TIMEPIECE

(71) Applicant: CASIO COMPUTER CO., LTD., Tokyo (JP)

(72) Inventors: Junichirou SUZUKI, Tokyo (JP); Kazumasa YOKOO, Tokyo (JP); Masaki MIYATA, Tokyo (JP); Kazuma KOBAYASHI, Tokyo (JP)

(73) Assignee: CASIO COMPUTER CO., LTD., Tokyo (JP)

(21) Appl. No.: 19/085,425

(22) Filed: Mar. 20, 2025

(30) Foreign Application Priority Data
Mar. 21, 2024 (JP) 2024-044379

(51) Int. Cl. G04B 37/00; G04B 39/00

(52) U.S. Cl. CPC G04B 37/0008; G04B 39/00

(57) ABSTRACT

A decorative bezel unit includes a first bezel and a second bezel. The first bezel is made of a brittle material, and surrounds an opening of a timepiece case and is fixed to an upper side of the timepiece case. The second bezel is made of a brittle material, and is disposed on side of the timepiece case and fixed to the timepiece case so that sideward movement of the second bezel is restricted. Upward movement of the second bezel is restricted by the first bezel.

### CROSS-REFERENCE TO RELATED APPLICATIONS

This application is based upon and claims the benefit of priority from the prior Japanese Patent Application No. 2024-044379, filed on Mar. 21, 2024, the entire contents of which are incorporated herein by reference.

### TECHNICAL FIELD

The present disclosure relates to a decorative bezel unit and a timepiece.

### DESCRIPTION OF RELATED ART

In JP 2021-169968 A, there is disclosed a wristwatch including a protective member for a crown. The protective member is fixed to the side surface of an exterior case with a bolt(s). If a brittle material such as sapphire is used for a decorative bezel such as the aforementioned protective member, the decorative bezel is likely to be damaged, and therefore bolt holes cannot be made.

### SUMMARY OF THE INVENTION

According to an aspect of the present disclosure, there is provided a decorative bezel unit including:
a first bezel that is made of a brittle material, and surrounds an opening of a timepiece case and is fixed to an upper side of the timepiece case; and
a second bezel that is made of a brittle material, and is disposed on side of the timepiece case and fixed to the timepiece case so that sideward movement of the second bezel is restricted,
wherein upward movement of the second bezel is restricted by the first bezel.

### BRIEF DESCRIPTION OF DRAWINGS

FIG. 1 is a front view of the main part of a timepiece according to an embodiment(s) of the present disclosure.

FIG. 2 is an exploded perspective view of the main part of the timepiece according to the embodiment.

FIG. 3 is a partial sectional view of the timepiece taken along line III-III in FIG. 1.

FIG. 4 is a partial sectional view of the timepiece taken along line IV-IV in FIG. 1.

FIG. 5 illustrates abutment surfaces of a side bezel and a timepiece case according to the embodiment.

FIG. 6 is a partial sectional view of the timepiece taken along line VI-VI in FIG. 1.

FIG. 7 is an exploded perspective view of a corner bezel according to the embodiment.

FIG. 8 is a partial sectional view of the timepiece taken along line VIII-VIII in FIG. 1.

FIG. 9A is an exploded perspective view of a modification of a fixing structure of a corner bezel.

FIG. 9B is an exploded perspective view of the modification of the fixing structure of the corner bezel.

FIG. 10A is a partial sectional view taken along line IX-IX in FIG. 1 for explaining the modification of the fixing structure of the corner bezel.

FIG. 10B is a partial sectional view taken along X-X line in FIG. 1 for explaining the modification of the fixing structure of the corner bezel.

FIG. 11 is a front view of the main part of the timepiece according to a modification of the present disclosure.

### DETAILED DESCRIPTION

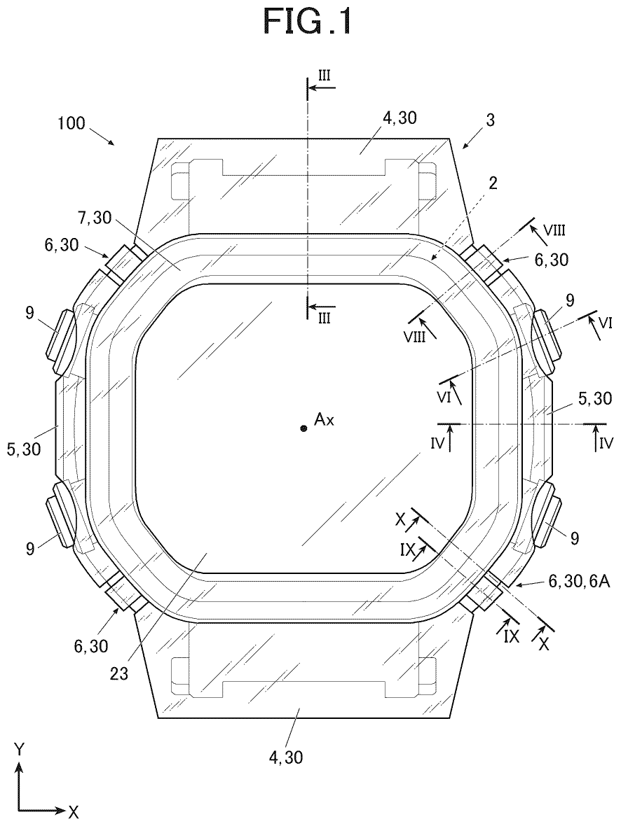

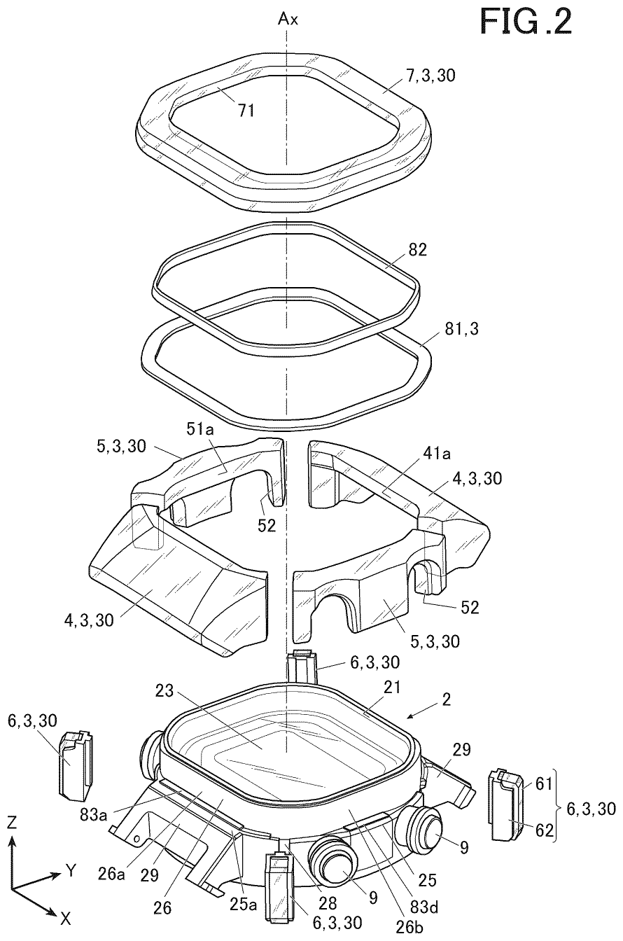

Hereinafter, one or more embodiments of the present disclosure will be described with reference to the drawings. As illustrated in FIG. 1 and FIG. 2, a timepiece 100 according to an embodiment(s) is a wristwatch that is worn on a wrist of a user. The timepiece 100 includes a timepiece case 2 and a bezel unit 3. Hereinafter, X, Y, Z directions of the timepiece 100 refer to those illustrated in the drawings. That is, the X direction and the Y direction refer to the 3:00-9:00 direction and the 12:00-6:00 direction in an analog timepiece, respectively, and the Z direction refers to the front-back direction of the timepiece 100 (timepiece case 2). In the Z direction, the visible side, which is the front side, may be referred to as the “upper side” or “upward”, and the back side may be referred to as the “lower side” or “downward”. Directions perpendicular to a central axis Ax of the timepiece case 2, the central axis Ax being parallel to the Z direction, are referred to as the “radial direction”, and a rotational direction around the central axis Ax is referred to as the “circumferential direction”. In a plane perpendicular to the central axis Ax, a side closer to the central axis Ax is referred to as the “inner side”, “inner diameter side” or the like, and a side far from the central axis Ax is referred to as the “outer side”, “outer diameter side” or the like.

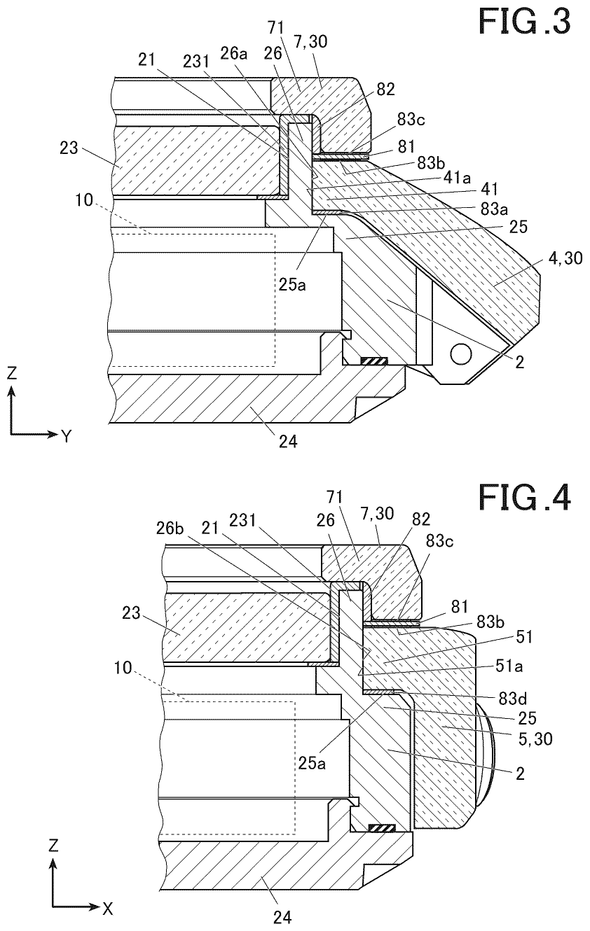

The timepiece case 2 is formed in an approximately rectangular tubular shape as viewed from above, namely, in front view or top view, and the opening on the front side (upper side) is closed with a transparent crystal 23 (windshield glass) that transmits visible light, and the opening on the back side (lower side) is closed with a back cover 24 (in FIG. 3, etc.). The material of the timepiece case 2 is, for example, metal, such as titanium or stainless steel, or hard resin, such as carbon. The material of the timepiece case 2 is not limited thereto, but any material as far as it is not a brittle material and can make the timepiece case 2 rigid. In the timepiece case 2, a timepiece module 10 (in FIG. 3, etc.) is housed. The timepiece module 10 includes, for example, a time display that displays time, a battery that serves as a power source, and a circuit board on which a control circuit is mounted. The top view shape of the timepiece case 2 is not limited to the rectangular tubular shape, and therefore may be a polygonal shape other than the rectangle shape, a circular shape, or the like.

As illustrated in FIG. 2 and FIG. 3, on the outer side surface of the timepiece case 2, a stepped part 25 is formed over approximately the entire periphery (circumference) of the timepiece case 2 so as to spread radially outward from its upper side to lower side stepwise.

The stepped part 25 has a tread surface 25a that is approximately perpendicular to the Z direction and faces upward. Of the timepiece case 2, a part above the stepped part 25 is a tubular part 26 having a rounded-corner-rectangular tubular shape in top view. The crystal 23 is fitted to the inner diameter side of the tubular part 26 with a first packing 231 in between.

The bezel unit 3 is an example of the decorative bezel unit according to the present disclosure, and includes two front bezels 4, two side bezels 5, four corner bezels 6, a top bezel 7, and a spacer 81. Of the bezel unit 3, decorative bezels 30, which are not below-described holding members 62 of the corner bezels 6 and the spacer 81, but the front bezels 4, the side bezels 5, below-described corner bezel bodies 61 of the corner bezels 6 and the top bezel 7, are made of a translucent material(s) that transmits visible light, such as sapphire glass. The material of the decorative bezels 30 is not limited to a translucent material, but any material in a wide range of brittle materials, which include inorganic glass, ceramics, and shells. Although not particularly limited, all the surfaces of each decorative bezel 30 are mirror-finished to a predetermined level of smoothness.

Of the bezel unit 3, the bezels excluding the top bezel 7, namely, the two front bezels 4, the two side bezels 5 and the four corner bezels 6, are disposed to form an annular shape in the plane perpendicular to the Z direction to cover the outer side surface of the timepiece case 2. The front bezels 4 and the side bezels 5 are examples of a second bezel(s) according to the present disclosure, and are disposed on the side (outer side) of the timepiece case 2 and fixed to the timepiece case 2 so that sideward movement of the front bezels 4 and the side bezels 5 is restricted. More specifically, the two front bezels 4 and the two side bezels 5 are disposed to correspond to the four sides of the approximately rectangular tubular timepiece case 2. The corner bezels 6 are examples of a third bezel(s) according to the present disclosure, and each are disposed, of the front bezels 4 and the side bezels 5, two bezels adjacent to one another. That is, the corner bezels 6 are disposed at the four corners of the timepiece case 2.

The two front bezels 4 are disposed on both sides of the timepiece case 2 in the Y direction. Each front bezel 4 is formed in a shape extending in the X direction to correspond to a side of the timepiece case 2 in the Y direction. Also, each front bezel 4 is disposed to cover the upper side of a strap attachment part 29 of the timepiece case 2, the strap attachment part 29 to which a strap (not illustrated) is attached. Each front bezel 4 is formed in an approximately inclined-plate shape that declines as its position in the Y direction is far from the central axis Ax to correspond to the shape of the strap attachment part 29.

Of each front bezel 4, an end part 41 on the inner diameter side abuts the timepiece case 2 and is fixed thereto. More specifically, the inner side surface of the end part 41 excluding both side parts in the X direction, namely, the center part in the X direction, is a first abutment surface 41a that is a flat surface. Of the timepiece case 2, parts corresponding to the first abutment surfaces 41a are first case-side flat surfaces 26a that are both side parts of the outer side surface of the tubular part 26 in the Y direction and are approximately perpendicular to the radial direction. In a state in which the front bezels 4 are disposed around the timepiece case 2, the first abutment surfaces 41a abut the first case-side flat surfaces 26a of the timepiece case 2. The lower surfaces of the end parts 41 of the front bezels 4 abut the tread surface 25a of the timepiece case 2 with double-sided tape 83a in between. In other words, the lower surfaces of the end parts 41 are adhered to the tread surface 25a of the timepiece case 2 with the double-sided tape 83a.

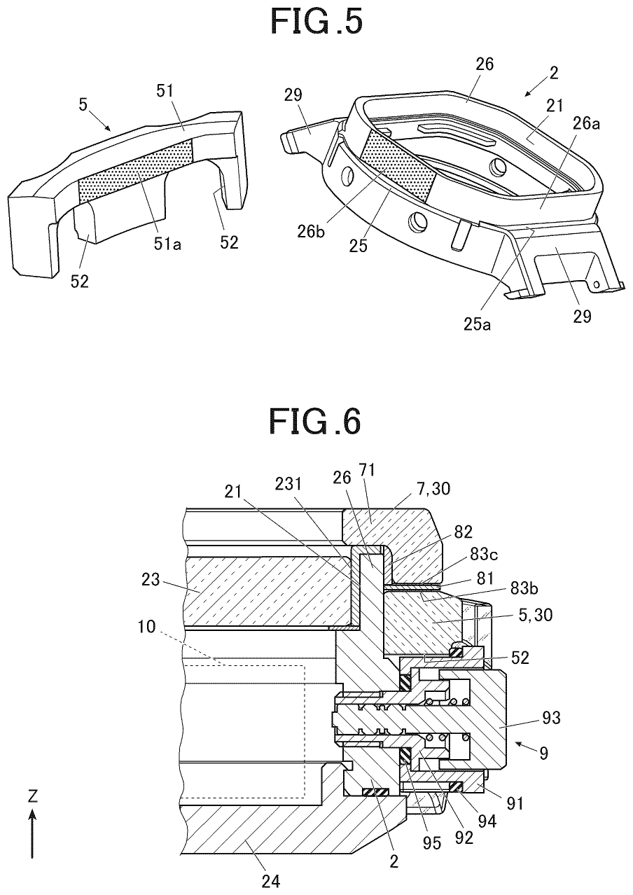

As illustrated in FIG. 2, FIG. 4 and FIG. 5, the two side bezels 5 are disposed on both sides of the timepiece case 2 in the X direction. Each side bezel 5 is formed in a shape extending in the Y direction to correspond to a side of the timepiece case 2 in the X direction.

Of each size bezel 5, an end part 51 on the inner diameter side abuts the timepiece case 2 and is fixed thereto. More specifically, the inner side surface of the end part 51 excluding both side parts in the Y direction, namely, the center part in the Y direction, is a second abutment surface 51a that is a flat surface. Of the timepiece case 2, parts corresponding to the second abutment surfaces 51a are second case-side flat surfaces 26b that are both side parts of the outer side surface of the tubular part 26 in the X direction and are approximately perpendicular to the radial direction. In a state in which the side bezels 5 are disposed around the timepiece case 2, the second abutment surfaces 51a abut the second case-side flat surfaces 26b of the timepiece case 2. The lower surfaces of the end parts 51 of the side bezels 5 abut the tread surface 25a of the timepiece case 2 with double-sided tape 83d in between. In other words, the lower surfaces of the end parts 51 of the side bezels 5 are adhered to the tread surface 25a of the timepiece case 2 with the double-sided tape 83d. The end parts 51 of the side bezels 5 are approximately the same as the end parts 41 of the front bezels 4 in height position in the Z direction. In FIG. 5, the second abutment surface 51a and the second case-side flat surface 26b are shown with a dot pattern to be easily recognized. The surface states of these flat surface regions are not particularly limited.

As illustrated in FIG. 2 and FIG. 6, at parts of each side bezel 5 corresponding to operation buttons 9, U-shaped clearance grooves (undercuts) 52 that open downward are formed. Each operation button 9 is fixed to a part of the timepiece case 2 under the tubular part 26, in a state in which the operation button 9 extends in a direction that intersects both the X direction and the Y direction and is approximately parallel to the radial direction. Each operation button 9 includes a decorative piece 91, a button pipe 92, and a push button 93. The decorative piece 91 is formed in an approximately cylindrical shape, and is disposed in its corresponding clearance groove 52 in a state in which an impact absorber 94 (e.g., made of nitrile rubber) is sandwiched between the decorative piece 91 and the side bezel 5 so that the decorative piece 91 does not come into direct contact with the side bezel 5. The side bezel 5 is pressed radially inward by the decorative piece 91 with the impact absorber 94 in between. The button pipe 92 is inserted in the decorative piece 91, and screwed to the timepiece case 2 in a state in which the flange of the bottom pipe 92 projecting on the outer diameter side holds the decorative piece 91. The gap between the button pipe 92 and the timepiece case 2 is sealed with an O-ring 95. The push button 93 is inserted in the button pipe 92 and supported thereby to be pressable in the radial direction. If the timepiece 100 employs an analog display method and includes a crown, the side bezels 5 in such a case may be configured in the same manner as the side bezels 5 in this embodiment to avoid contact with the crown.

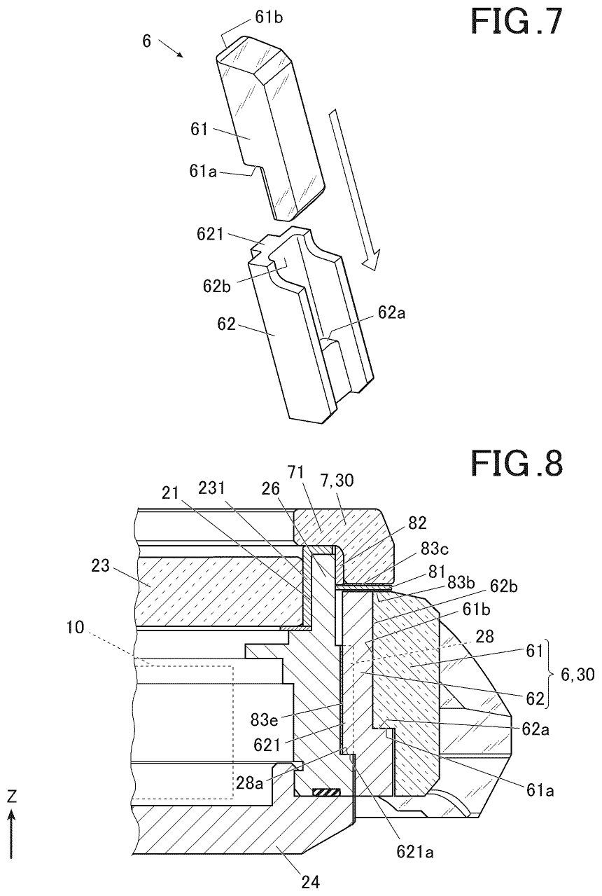

As illustrated in FIG. 1, FIG. 2, FIG. 7 and FIG. 8, the four corner bezels 6 are disposed at the corners between the front bezels 4 and the side bezels 5 of the timepiece 100 in top view. Each corner bezel 6 includes a corner bezel body 61 and a holding member 62 that holds the corner bezel body 61. The corner bezel body 61 is formed in an approximately rectangular column shape that is long in the Z direction. The surface of the corner bezel body 61 corresponding to the inner diameter side of the timepiece case 2, namely, the surface on the inner diameter side of the corner bezel body 61, is formed stepwise and has a tread surface 61a facing downward. The holding member 62 has a groove that opens radially outward and extends in the Z direction, and houses the corner bezel body 61 in the groove. In the groove, the holding member 62 has a tread surface 62a facing upward that corresponds to the tread surface 61a of the corner bezel body 61. The corner bezel body 61 is adhered to the holding member 62 with an adhesive in a state in which the tread surface 61a abuts the tread surface 62a of the holding member 62 in the Z direction, and an end surface 61b on the inner diameter side abuts a groove bottom surface 62b of the holding member 62 in the radial direction. The method for adhering the corner bezel body 61 to the holding member 62 is not limited to an adhesive, but, for example, double-sided tape or the like. On the surface on the inner diameter side of the holding member 62, a projection 621 extending in the Z direction is formed. At each of the four corners of the timepiece case 2, a groove 28 (in FIG. 2) extending in the Z direction is formed to correspond to the projection 621. Each corner bezel 6 is disposed at a corner of the timepiece case 2 by the projection 621 of the holding member 62 of the corner bezel 6 being fitted in the groove 28 of the timepiece case 2. The top surface of the projection 621 of the holding member 62 is adhered to the bottom surface of the groove 28 of the timepiece case 2 with double-sided tape 83e. At the time, a tread surface 621a facing downward at the lower end of the projection 621 of the holding member 62 abuts a tread surface 28a facing upward in the groove 28 of the timepiece case 2. The holding member 62 is interposed between the front bezel 4 and the side bezel 5 in the circumferential direction, or between the front bezel 4 or the side bezel 5 and the corner bezel body 61 in the circumferential direction. The material of the holding member 62 is, for example, metal, such as titanium or stainless steel, or hard resin, such as carbon. The material of the holding member 62 is not limited thereto, but any material as far as it is not a brittle material and can make the holding member 62 rigid.

The top bezel 7 is an example of a first bezel according to the present disclosure, and is disposed above the timepiece case 2 as illustrated in FIG. 2 and FIG. 3. The top bezel 7 is formed in a rectangular annular shape in top view to correspond to the shape of the timepiece case 2 in top view, and has a flange 71 projecting inward over the entire periphery. The top bezel 7 is fitted and fixed to the timepiece case 2 by being press-fitted to the outer diameter side of the tubular part 26 of the timepiece case 2. The top bezel 7 is fixed to the upper side of the timepiece case 2 so as to surround an opening 21 of the timepiece case 2, namely, so as to surround the crystal 23 fitted in the opening 21. How to fix the top bezel 7 to the timepiece case 2 is not limited to press-fitting. Between the top bezel 7 and the tubular part 26, a second packing 82 is disposed so that the top bezel 7 and the tubular part 26 do not come into direct contact with one another. The second packing 82 is made of a material different from that of the first packing 231, and is lower in hardness (softer) than the first packing 231. The flange 71 of the top bezel 7 is disposed above the tubular part 26 and the first packing 231 so that the tubular part 26 and the first packing 231 are invisible from the front side.

Between the top bezel 7 and the timepiece case 2, the front bezels 4, the side bezel 5 and the corner bezels 6, which are annularly disposed, are sandwiched in the Z direction, thereby being fixed, so that upward movement of the front bezels 4, the side bezels 5 and the corner bezels 6 is restricted. More specifically, the end part 41 of each front bezel 4 is fixed between the tread surface 25a of the timepiece case 2 and the lower end surface of the top bezel 7, and the end part 51 of each side bezel 5 is fixed between the tread surface 25a of the timepiece case 2 and the lower end surface of the top bezel 7. As to each corner bezel 6, the holding member 62 is fixed between the tread surface 28a of the timepiece case 2 and the lower end surface of the top bezel 7, and the corner bezel body 61 is fixed between the tread surface 62a of the holding member 62 and the lower end surface of the top bezel 7.

Between the top bezel 7 and the bezels 4, 5, 6, the spacer 81 made of metal (e.g., titanium) is interposed so that the top bezel 7 and the bezels 4, 5, 6 (corner bezel bodies 61) do not come into direct contact with one another. The spacer 81 is formed in a rectangular annular shape in top view to correspond to the shape of the top bezel 7 in top view, and is disposed under the top bezel 7 over the entire periphery of the timepiece case 2. To the lower surface of the spacer 81, double-sided tape 83b is attached, and this double-sided tape 83b adheres the spacer 81 to the front bezels 4, the side bezels 5 and the corner bezels 6 (corner bezel bodies 61 and holding members 62). To the upper surface of the spacer 81, double-sided tape 83c is attached, and this double-sided tape 83c adheres the spacer 81 to the top bezel 7. The material of the spacer 81 is, for example, metal, such as titanium or stainless steel, or hard resin, such as carbon. The material of the spacer 81 is not limited thereto, but any material as far as it is not a brittle material and can make the spacer 81 rigid.

Next, a procedure for combining the bezel unit 3 with the timepiece case 2 will be described. It is assumed that the timepiece module 10 has been housed in the timepiece case 2, the crystal 23 and the back cover 24 have been attached to the timepiece case 2, and the operation buttons 9 have been combined with the timepiece case 2 beforehand. It is also assumed that the four corner bezels 6 each have been assembled beforehand.

First, as illustrated in FIG. 2 and FIG. 8, the four corner bezels 6 are attached to the four corners of the timepiece case 2. More specifically, the corner bezels 6 are disposed at the respective corners of the timepiece case 2 by the projections 621 on the inner diameter side of the holding members 62 of the corner bezels 6 being fitted into the grooves 28 at the respective corners of the timepiece case 2. Each corner bezel 6 is tentatively fixed by being adhered to the bottom surface of the groove 28 of the timepiece case 2 with the double-sided tape 83e attached to the top surface of the projection 621. At the time, the tread surface 621a facing downward at the lower end of the projection 621 of the holding member 62 is made to abut the tread surface 28a facing upward in the groove 28 of the timepiece case 2.

Next, as illustrated in FIG. 2, FIG. 3 and FIG. 4, the two front bezels 4 and the two side bezels 5 are attached to the timepiece case 2 in sequence. Each front bezel 4 is tentatively fixed by the lower surface of the end part 41 being adhered to the tread surface 25a of the timepiece case 2 with the double-sided tape 83a in the state in which the first abutment surface 41a of the end part 41 abuts the first case-side flat surface 26a of the timepiece case 2 in the radial direction. Each side bezel 5 is tentatively fixed by the lower surface of the end part 51 being adhered to the tread surface 25a of the timepiece case 2 with the double-sided tape 83d in the state in which the second abutment surface 51a of the end part 51 abuts the second case-side flat surface 26b of the timepiece case 2 in the radial direction. At the time, the upper end surfaces of the front bezels 4, the side bezels 5 and the corner bezels 6 are approximately flush with one another in the plane approximately perpendicular to the Z direction.

Next, the spacer 81 is disposed in the timepiece case 2. The spacer 81 with the double-sided tapes 83c, 83b attached to its upper surface and lower surface, respectively, is inserted into the tubular part 26, thereby being disposed in the timepiece case 2. The spacer 81 is tentatively fixed by being adhered to the upper surfaces of the front bezels 4, the side bezels 5 and the corner bezels 6 with the double-sided tape 83b attached to the lower surface of the spacer 81.

Next, the top bezel 7 is attached to the timepiece case 2. The top bezel 7 is press-fitted from above to the outer diameter side of the tubular part 26 of the timepiece case 2 with the second packing 82 in between, the second packing 82 being disposed in advance on the outer diameter side of the tubular part 26. The top bezel 7 is press-fitted until it sufficiently abuts the front bezels 4, the side bezels 5 and the corner bezels 6 with the spacer 81 in between. Thus, the front bezels 4, the side bezels 5 and the corner bezels 6 are appropriately fixed in the state in which they are sandwiched between the timepiece case 2 and the top bezel 7.

Objects of the present disclosure include

appropriately fixing decorative bezels to a timepiece case without using screws, such as bolts. As described above, according to this embodiment, the top bezel 7 (first bezel) made of a brittle material surrounds the opening 21 and is fixed to the upper side of the timepiece case 2, and the front bezels 4 and the side bezels 5 (second bezels) made of a brittle material are disposed on the side of the timepiece case 2 and fixed to the timepiece case 2 so that sideward movement (movement to the inner diameter side) of the front bezels 4 and the side bezels 5 is restricted. Upward movement of the front bezels 4 and the side bezels 5 is restricted by the top bezel 7. Thus, the top bezel 7, the front bezels 4 and the side bezels 5 can be appropriately fixed to the timepiece case 2 without being directly fixed to the timepiece case 2 with screws. In addition, since the necessity of screw holes, which reduce the strength of the decorative bezels 30, is eliminated, the impact resistance of the timepiece 100 can be enhanced.

Furthermore, according to this embodiment, the top bezel 7 surrounds the crystal 23 (windshield glass), with which the opening 21 of the timepiece case 2 is closed, and is fixed to the timepiece case 2. Thus, the holding parts (tubular part 26 and first packing 231) and so forth around the crystal 23 can be covered with the top bezel 7 to be invisible from the front side.

Furthermore, according to this embodiment, the second packing 82 (fixing member) is disposed between the inner side surface of the top bezel 7 and the tubular part 26 at the upper part of the metallic timepiece case 2. This makes it possible to avoid direct contact (abutment) between the top bezel 7 and the timepiece case 2, thereby preventing damage to the top bezel 7, which is made of a brittle material. The fixing member interposed between the top bezel 7 and the timepiece case 2 (tubular part 26) may not be a packing. As far as the fixing member can appropriately fix the top bezel 7 to the timepiece case 2 without the top bezel 7 and the timepiece case 2 directly contacting one another, any fixing member, for example, an adhesive, can be used.

Furthermore, according to this embodiment, the second packing 82 interposed between the top bezel 7 and the timepiece case 2 is lower in hardness (softer) than the first packing 231 interposed between the crystal 23 and the timepiece case 2. This makes it possible to appropriately press-fit the top bezel 7 to the outer diameter side of the timepiece case 2 (tubular part 26) even in the state in which the crystal 23 is fitted (press-fitted) to the inner diameter side of the timepiece case 2 (tubular part 26).

Furthermore, according to this embodiment, sideward movement of the front bezels 4 and the side bezels 5 (second bezels), which are disposed on the side of the timepiece case 2, to the timepiece case 2 is restricted by the double-sided tape (adhesive tape) 83a interposed between the front bezels 4 and the tread surface 25a of the timepiece case 2 and by the double-sided tape (adhesive tape) 83d interposed between the side bezels 5 and the tread surface 25a of the timepiece case 2. Thus, the front bezels 4 and the side bezels 5 can be fixed more firmly. The members that restrict movement of the second bezels may not be the double-sided tapes 83a, 83d attached to the tread surface 25a. For example, a packing(s) or an adhesive(s) may be interposed between the second bezels and the side surface of the timepiece case 2 (e.g., first case-side flat surfaces 26a and second case-side flat surfaces 26b). In this case too, sideward movement of the second bezels to the timepiece case 2 can be appropriately restricted by the packing or the adhesive.

Embodiments to which the present disclosure is applicable are not limited to the above-described embodiment, and therefore various modifications can be made without departing from the scope of the present disclosure. For example, in the above embodiment, the decorative bezels 30, with which the timepiece case 2 is decorated, are divided bezels disposed in both the circumferential direction and the up-down direction of the timepiece case 2. However, as far as the decorative bezel unit according to the present disclosure includes the first bezel fixed to the upper side of the timepiece case and the second bezel(s) disposed on the side of the timepiece case, the divided pattern of decorative bezels or the like is not particularly limited. For example, the second bezel(s) disposed on the side of the timepiece case may be a single annular member.

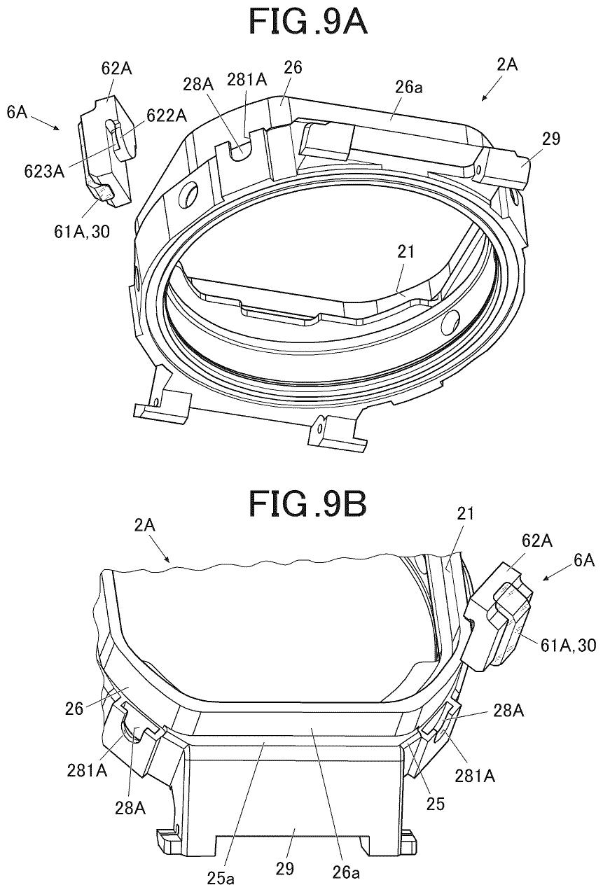

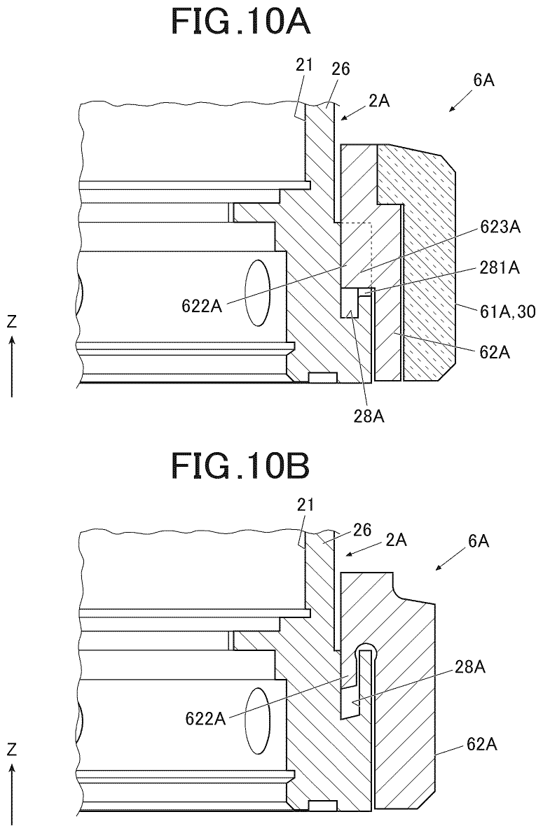

Furthermore, in the above embodiment, the corner bezels 6 are fixed to the timepiece case 2 only by the double-sided tape 83e. If the adhesiveness of the double-sided tape 83e decreases and the pressure applied by the top bezel 7 to the corner bezels 6 in the Z direction decreases, the corner bezels 6 may fall off to the outer diameter side (outward). Then, for example, the corner bezels 6 may be directly engaged with the timepiece case 2. More specifically, as illustrated in FIG. 9A, FIG. 9B, FIG. 10A and FIG. 10B, a timepiece case 2A has pocket-shaped engagement recesses 28A at the four corners where corner bezels 6A are disposed, the engagement recesses 28A opening upward. The side wall of each engagement recess 28A has a notch 281A that is formed at the center of the side wall in the circumferential direction and occupies approximately half the upper side of the side wall. A holding member 62A of each corner bezel 6A has an engagement projection 622A that is formed on the surface on the inner diameter side and projects downward to correspond to the engagement recess 28A of the timepiece case 2A. In an opening of the engagement projection 622A, a solid part 623A is provided at the center in the circumferential direction. The solid part 623A is fitted with the notch 281A of the engagement recess 28A. The holding member 62A with a corner bezel body 61A adhered as in the above embodiment is engaged with the timepiece case 2A by the engagement projection 622A being inserted into the engagement recess 28A from above. At the time of the insertion, the solid part 623A of the engagement projection 622A is guided by the notch 281A of the engagement recess 28A. The engagement projection 622A is fixed to the engagement recess 28A more firmly by the engagement recess 28A filled with an adhesive. Thus, outward movement of the corner bezel body 61A is restricted by the holding member 62A (metallic member), which is interposed between the corner bezel body 61A and the front and side bezels 4, 5 adjacent to one another, and to which the corner bezel body 61A is adhered, engaged with the timepiece case 2A. This makes it possible to avoid contact between the front bezels 4, the side bezels 5 and the corner bezel bodies 61A, thereby preventing damage to these, and also can prevent the corner bezels 6A from falling off the timepiece case 2A.

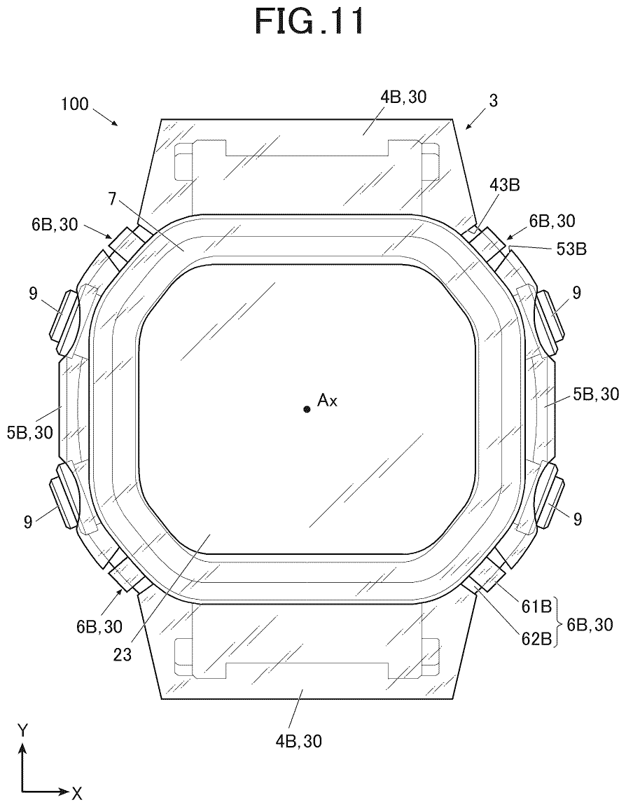

Alternatively, a front bezel and a side bezel (two second bezels) adjacent to one another in the circumferential direction may restrict movement of a corner bezel (third bezel) therebetween. In this case, as illustrated in FIG. 11, a front bezel 4B and a side bezel 5B on both sides of a corner bezel 6B in the circumferential direction have side surfaces 43B, 53B, respectively, that face one another in the circumferential direction with the corner bezel 6B in between and are inclined to be closer to one another as they are away from the central axis Ax of the timepiece case 2 in the radial direction. In addition, of the corner bezel 6B, a holding member 62B that faces the front bezel 4B and the side bezel 5B in the circumferential direction has two side surfaces in the circumferential direction that are inclined such that the width of the holding member 62B is narrower as they are away from the central axis Ax of the timepiece case 2 in the radial direction. Thus, outward movement of the corner bezel 6B (corner bezel body 61B) is restricted by the front bezel 4B and the side bezel 5B in the state in which the holding member 62B (metallic member) is interposed between the corner bezel body 61B and the front and side bezel 4B, 5B adjacent to one another. This makes it possible to avoid contact between the front bezels 4, the side bezels 5 and the corner bezel bodies 61A are, thereby preventing damage to these, and also can prevent the corner bezels 6B from falling off the timepiece case 2.

Furthermore, as to the abutment surface (i.e., contact surface) of each decorative bezel 30 to the timepiece case 2, as far as movement of the decorative bezel 30 can be restricted, its position is not particularly limited. For example, the abutment surface may be present not at the center of each decorative bezel 30 but at an end thereof. It is preferable that the abutment surface of each decorative bezel 30 be set so as to ensure as wide an area as possible in accordance with the divided pattern of decorative bezels 30.

Furthermore, to/on the lower surface of each decorative bezel 30 (e.g., the lower surface of the top bezel 7) made of a translucent material, an opaque layer may be applied or vapor-deposited so that the internal components, such as the double-sided tapes, are invisible from the front side.

Furthermore, the present disclosure is applicable to a wide range of decorative bezel units (decorative structures) in which the first bezel and the second bezel(s) made of a brittle material are fixed to a timepiece case without using screws. The material of decorative bezels excluding the first bezel and the second bezel(s) is not limited to a brittle material. The material of the timepiece case is not particularly limited either.

1. A decorative bezel unit comprising:
a first bezel that is made of a brittle material, and surrounds an opening of a timepiece case and is fixed to an upper side of the timepiece case; and
a second bezel that is made of a brittle material, and is disposed on side of the timepiece case and fixed to the timepiece case so that sideward movement of the second bezel is restricted,
wherein upward movement of the second bezel is restricted by the first bezel.

2. The decorative bezel unit according to claim 1, wherein the first bezel surrounds a windshield glass with which the opening of the timepiece case is closed, and is fixed to the timepiece case.

3. The decorative bezel unit according to claim 2,
wherein the timepiece case is made of a metal, and
wherein a fixing member is disposed between an inner side surface of the first bezel and an upper part of the timepiece case.

4. The decorative bezel unit according to claim 2, further comprising:
a first packing interposed between the windshield glass and the timepiece case; and
a second packing interposed between the first bezel and the timepiece case,
wherein the second packing is lower in hardness than the first packing.

5. The decorative bezel unit according to claim 1, wherein the sideward movement of the second bezel to the timepiece case is restricted by a packing or an adhesive interposed between the second bezel and a side surface of the timepiece case or by an adhesive tape interposed between the second bezel and a tread surface of the timepiece case.

6. The decorative bezel unit according to claim 1,
wherein second bezels each being the second bezel are disposed on the side of the timepiece case,
wherein the decorative bezel unit further comprises a third bezel that is made of a brittle material, and is disposed between, of the second bezels, two second bezels adjacent to one another,
wherein the third bezel is adhered to a metallic member interposed between the third bezel and the two second bezels, and
wherein outward movement of the third bezel is restricted by the metallic member engaged with the timepiece case.

7. The decorative bezel unit according to claim 1,
wherein second bezels each being the second bezel are disposed on the side of the timepiece case,
wherein the decorative bezel unit further comprises a third bezel that is made of a brittle material, and is disposed between, of the second bezels, two second bezels adjacent to one another, and
wherein outward movement of the third bezel is restricted by the two second bezels in a state in which a metallic member is interposed between the third bezel and the two second bezels.

8. A timepiece comprising:
a timepiece module;
a timepiece case that has an opening and houses the timepiece module;
a first bezel that is made of a brittle material, and surrounds the opening of the timepiece case and is fixed to an upper side of the timepiece case; and
a second bezel that is made of a brittle material, and is disposed on side of the timepiece case and fixed to the timepiece case so that sideward movement of the second bezel is restricted,
wherein upward movement of the second bezel is restricted by the first bezel.

9. The timepiece according to claim 8, wherein the first bezel surrounds a windshield glass with which the opening of the timepiece case is closed, and is fixed to the timepiece case.

10. The timepiece according to claim 9,
wherein the timepiece case is made of a metal, and
wherein a fixing member is disposed between an inner side surface of the first bezel and an upper part of the timepiece case.

11. The timepiece according to claim 9, further comprising:
a first packing interposed between the windshield glass and the timepiece case; and
a second packing interposed between the first bezel and the timepiece case,
wherein the second packing is lower in hardness than the first packing.

12. The timepiece according to claim 8, wherein the sideward movement of the second bezel to the timepiece case is restricted by a packing or an adhesive interposed between the second bezel and a side surface of the timepiece case or by an adhesive tape interposed between the second bezel and a tread surface of the timepiece case.

13. The timepiece according to claim 8,
wherein second bezels each being the second bezel are disposed on the side of the timepiece case,
wherein the timepiece further comprises a third bezel that is made of a brittle material, and is disposed between, of the second bezels, two second bezels adjacent to one another,
wherein the third bezel is adhered to a metallic member interposed between the third bezel and the two second bezels, and
wherein outward movement of the third bezel is restricted by the metallic member engaged with the timepiece case.

14. The timepiece according to claim 8,
wherein second bezels each being the second bezel are disposed on the side of the timepiece case,
wherein the timepiece further comprises a third bezel that is made of a brittle material, and is disposed between, of the second bezels, two second bezels adjacent to one another, and
wherein outward movement of the third bezel is restricted by the two second bezels in a state in which a metallic member is interposed between the third bezel and the two second bezels.
